(19) United States
(12) Patent Application Publication
(10) Pub. No.: US 2002/0019865 A1
(43) Pub. Date: Feb. 14, 2002

(54) Method and apparatus to configure video operation

(76) Inventor: Jim B. Estipona, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/823,513

(22) Filed: Mar. 30, 2001

Related U.S. Application Data
(63) Continuation-in-part of application No. 09/633,454, filed on Aug. 7, 2000.

(51) Int. Cl. G06F 15/16; G06F 15/173

(52) U.S. Cl. 709/223; 709/231

(57) ABSTRACT

A method includes checking the vertical blanking interval of a video signal for an announcement signal. When the announcement signal is found, operation is in a first enhanced video mode. When the announcement signal is not found, a predetermined trigger channel is checked for the presence of a trigger signal. When the trigger signal is found, operation is in a second enhanced video mode.

### BACKGROUND

1. Field

The invention relates to the processing of events by a computer system.

2. Background Information

A computer system is any device comprising a processor coupled to a memory, the memory to store instructions and data which may be supplied to the processor to carry out operations. These instructions, together with or including the data, may be referred to as software. Examples of computer systems are personal computers, handheld computers, server computers, and so on. A computer system may display information received from a first source such as a broadcast channel. This information may include audio and/or video information. The computer system may also receive information from a second source such as the Internet or other computer network. The information from the first source may be coordinated with information from the second source. Information from either source may include events, e.g. commands to the computer system. These events, also known as triggers, may be received and processed by the computer system for any number of reasons. Reasons include to coordinate rendering of content from the first and second sources and to affect the rendering of content by the computer system, to name just a couple.

The Advanced Television Enhancement Forum (ATVEF), and industry group, has produced a specification for the delivery of enhanced video content to computer systems called the Enhanced Content Specification (Copyright 1998, 1999 ATVEF). Enhanced video content is video content delivered in coordination with other types of content, such as web pages and scripts. Scripts are sequences of commands which may be delivered to and executed by a computer system to perform one or more operations, such as to move a pointer or resize a window. For example, video content may be delivered to a computer system via a broadband data channel, along with triggers which specify Uniform Resource Locators for web pages to render in coordination with the video content. Triggers may also include scripts.

According to the Enhanced Content Specification, triggers may be delivered either via the same channel as the video (mode A), or via a separate channel to the Internet or other network (mode B). For example in mode A the triggers may be delivered via the vertical blanking interval of the video signal. Alternately, in mode B, the video may be delivered via broadband and the triggers may be delivered via a narrow band (low bandwidth) Internet channel. Computer systems may benefit from software which provides for receiving and processing video, triggers, and other content in either mode A or mode B.

### BRIEF DESCRIPTION OF THE DRAWINGS

The subject matter regarded as the invention is particularly pointed out and distinctly claimed in the concluding portion of the specification. The invention, however, may be further understood by reference to the following detailed description read with reference to the accompanying drawings.

FIG. 1 shows an embodiment of software in accordance with the present invention.

FIG. 2 shows an embodiment of software in accordance with the present invention.

FIG. 3 shows an embodiment of a computer system in accordance with the present invention.

FIG. 4 shows an embodiment of a method in accordance with the present invention.

### DETAILED DESCRIPTION

The embodiments described herein are merely illustrative, and one skilled in the art will appreciate that numerous modifications can be made which nonetheless fall within the scope of the present invention.

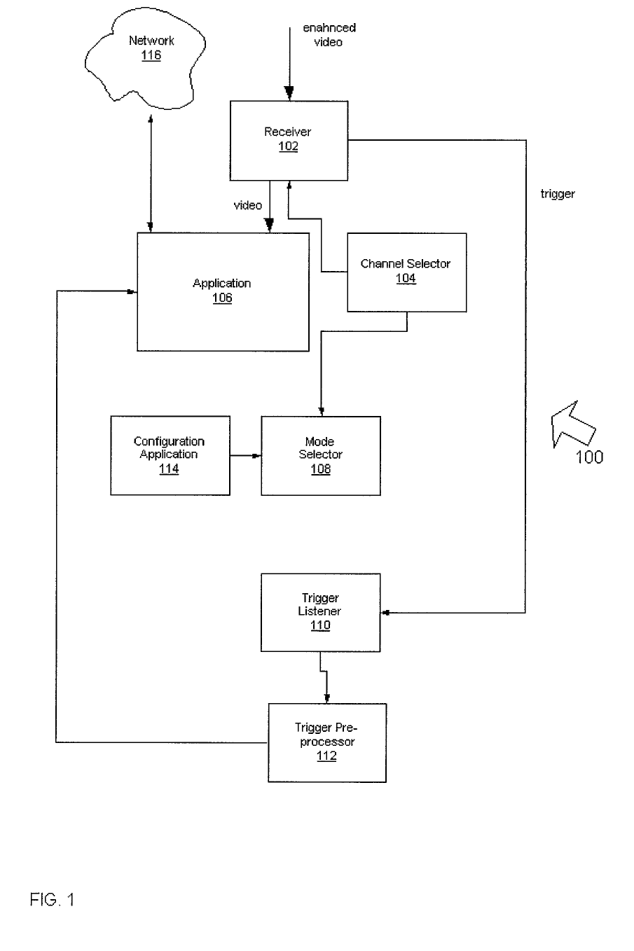

FIG. 1 shows an embodiment 100 of software in accordance with the present invention. Embodiment 100 comprises software for operating in mode A, that is, for receiving and processing triggers from the same broadband channel as the video is received. For example, in mode A the triggers may be received by way of the vertical blanking interval (VBI) of the video signal. For the purposes of describing the present invention, this and other embodiments may be described in terms of “components” or “applications”, e.g. functional blocks. Of course, software is highly malleable and the actual packaging of functionality may vary according to different embodiments. The description of components and applications should therefor be understood to be merely illustrative and not to imply that the software is necessarily organized into particular distinct packages such as libraries, objects, executables, and so on.

Embodiment 100 includes a receiver component 102 to receive a video signal. The video signal may be received via a broadband channel, such as a wireless video broadcast channel, satellite channel, cable modem channel, and so on. Receiver separates video information from trigger information and passes the video information to display application 106, which displays the video on a display device, such as a monitor or screen. Trigger information is passed to trigger listener component 110.

A trigger may include various fields including a URL of a web page for application 106 to display in coordination with the video content. The trigger may also include a script (for example, a plurality of statements in the well-known JavaScript language) to be processed by application 106 as well as an expiration time after which the trigger is to be discarded and not processed. Of course the trigger may include other fields not important to an understanding of the present invention.

The main purpose of trigger listener 110 is to receive the trigger from the receiver 102 and to pass the trigger on to the trigger pre-processor 112. Trigger listener 110 may also perform certain analysis of the trigger. For example, trigger listener 110 may check to determine whether or not the trigger comprises a script. Trigger listener passes the trigger to trigger pre-processor 112.

Trigger pre-processor 112 parses the trigger to translate the trigger into actions to be taken by application 106. Trigger pre-processor may check to determine if the URL comprised by trigger identifies a web page other than the one currently being displayed by application 106. If so, trigger pre-processor may not instruction application 106 to load the web page again (doing so would merely waste processing resources of the computer system). If however the URL identifies a page different than the one currently displayed, pre-processor 112 may instruct application 106 to receive and display the new web page from network 116 using a network channel different from the video channel. If the trigger comprises a script, pre-processor 112 may provide the script to application 106 with instruction to process the instructions of the script. If the expiration time for the trigger is past, pre-processor 112 may discard the trigger without instructing application 106 to perform any processing.

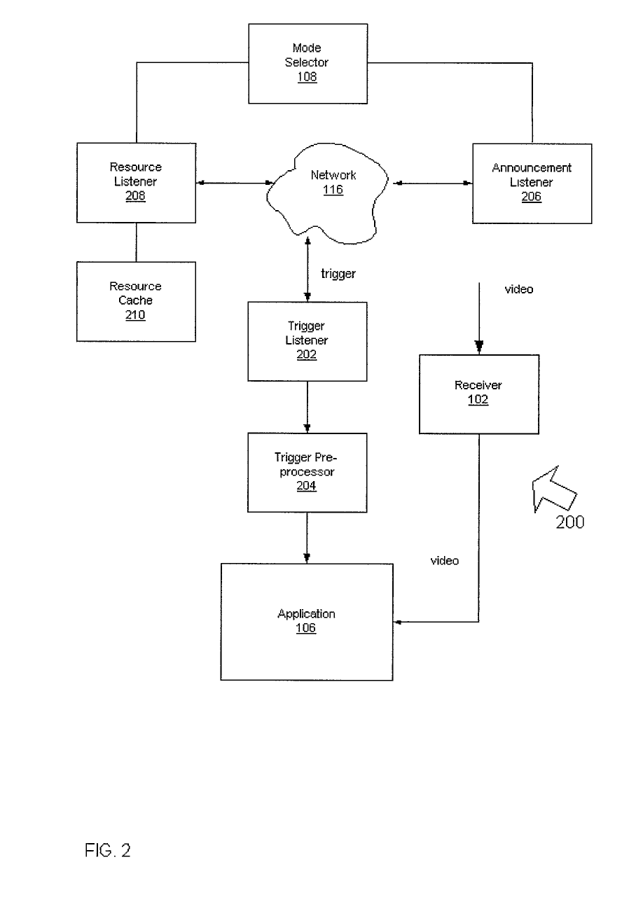

Channel selector 104 may provide a user interface so that a person using the computer system with the software embodiment 100 may select a channel from which to receive video, much as a person may choose the channel to receive on their television. Channel selector 104 may configure receiver 102 to receive the selected channel. Channel selector 104 may also communicate the channel selection to mode selector 108. When operating in mode B (where triggers and other information related to the video content is received via a network channel different from the video channel) the selected channel may be used by mode selector 108 to enable triggers to be received from the network 116, in a manner to be described in conjunction with FIG. 2. Mode selector 108 may cause the software to operate in one of mode A or mode B according to a mode selection provided by configuration application 114. For example, in an embodiment operating in mode A mode selector 108 may create (instantiate) trigger listener 110 in memory such that trigger listener 110 receives triggers from receiver 102. In an embodiment operating in mode B mode selector 108 may create (instantiate) trigger listener 202 in memory such that trigger listener 202 receives triggers from network 116 (refer to FIG. 2). The mode selection may be made by the user or by some other person responsible for configuring the system.

FIG. 2 shows an embodiment 200 of software in accordance with the present invention. Embodiment 200 comprises software for operating in mode B, that is, for receiving and processing triggers received from a different channel than the video is received. Video is received by video receiver 102 from a video channel, and triggers are received by trigger listener 202 from network 116. Triggers are passed to trigger pre-processor 204 which operates in a manner similar to the trigger pre-processor 112 of FIG. 1. Trigger pre-processor 204 instructs application 106 to process triggers in a manner similar to the manner described with reference to FIG. 1.

Embodiment 200 includes an announcement listener 206 which communicates with network 116 to determine announcements available for a selected channel. Recall that in mode B a video channel may be selected using channel selector 104. Mode selector 108 may communicate the selected channel to announcement listener 206, which may then communicate with a known address of network 116 to retrieve an announcement for the channel. An announcement may include such information as which “enhancement” (e.g. web pages and other content) are available to supplement video for a selected channel, the period of time during which such enhancements are available, and the bandwidth needed to retrieve those enhancements from the network 116. Announcement information may also include the network address from which trigger listener 202 may receive triggers from the network 116. For example, the network address for triggers could include an Internet Protocol (IP) address and port number with which the trigger listener 202 may communicate to receive triggers.

When operating in mode B a resource listener 208 communicates with the network the retrieve and cache enhancements for the channel. Enhancements may be retrieved from a network address identified in the announcement for the selected channel and may be cached in resource cache 210. Triggers received from the network may identify which enhancements to process from the cache in conjunction with the received video information. In an embodiment cached enhancements are identified by URLs having the “lid:” protocol (as opposed, for example, to the “http:” protocol which would identify enhancements to receive from the network 116 in mode A). Caching of enhancements in cache 210 may improve the performance of enhancement processing in conjunction with received video information.

When a new channel selection is received by mode selector 108 in mode B, mode selector 108 may request announcement listener 206 to retrieve the network addresses from which to receive triggers and enhancements for the selected channel. Mode selector 108 may then communicate these new addresses to trigger listener 202 and resource listener 208 to reconfigure these components to operate with new channel.

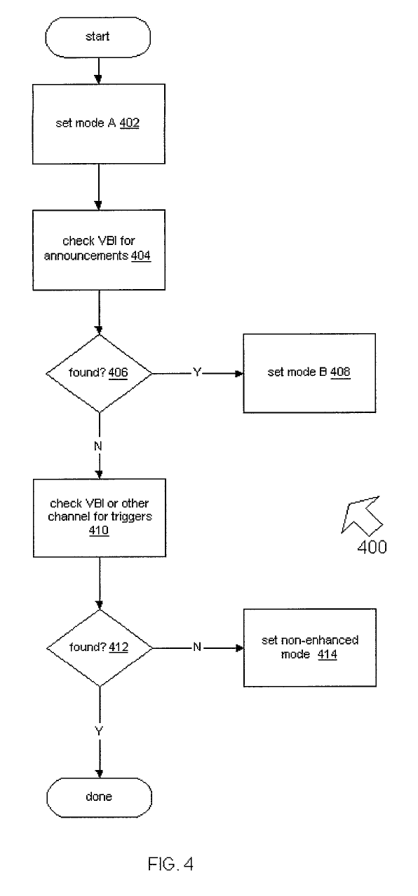

In one embodiment, the operating mode may be configured automatically to one of either mode A or mode B. FIG. 4 illustrates an embodiment 400 of a method of operating mode configuration in accordance with the present invention. The method may be performed, for example, each time reception of video is initiated, and each time a channel change is performed. At 402 the mode is initially set to mode A. The VBI of the video signal is checked for announcement signals at 404. In one embodiment, the VBI of a field (one half of an interlaced video frame) of video signal is first checked for datagrams related to enhanced video. In one embodiment, these datagrams are identified by packet addresses in the range 0x4b0 to 0x4bf. Once the enhanced video IP datagrams are identified, they are analyzed for announcement signals. The manner of detecting enhanced video IP datagrams, and analyzing such datagrams for announcements, is well known. See for example “Transmission of IP over a Vertical Blanking Interval”, RFC 2728, by the Internet Engineering Task Force. See also the “ATVEF Specification”, version 1-1 R26, Feb. 2, 1999 by the ATVEF Working Group.

At 406, if announcements are found the mode is set to mode B at 408. Otherwise, the VBI, or some other channel (for example a network connection) from which triggers are to be obtained in mode A, is checked for trigger signals. At 412, if triggers are found the method concludes, with the mode still set to the initial mode A. Otherwise, the mode is set to non-enhanced at 414. In non-enhanced mode, no web pages or other Internet Protocol (IP) content is received.

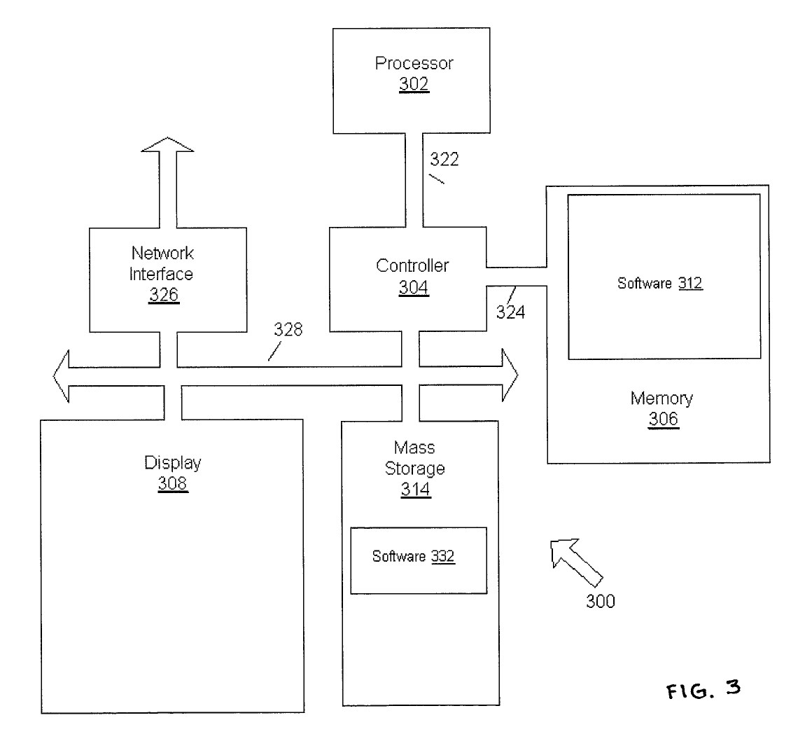

Referring back to FIG. 3, a computer system embodiment 300 in accordance with the present invention is shown. Embodiment 300 comprises a processor 302 coupled to a controller 304 by way of a processor bus 322, commonly referred to as a front side bus. Bus controller 304 is coupled to memory 306 via memory bus 324. Bus controller 304 is also coupled to various peripheral devices such as mass storage 314, network interface 326, and display 308 via I/O bus 328. Network interface 326 provides apparatus 300 with access to networks such as the Internet or corporate intranets.

Memory 306 stores software 312, such as the software and method embodiments described in connection with FIGS. 1, 2, and 4. Memory 306 is typically a form of random access memory (RAM), although in some embodiments memory 306 could comprise non-volatile memory such as a hard disk, flash memory, or CD ROM. Memory 306 supplies the instructions of software stored therein to processor 302 for execution. Of course, mass storage 314 may store and archived version 332 of software 312 for loading into memory 306 as the need arises.

While certain features of the invention have been illustrated as described herein, many modifications, substitutions, changes and equivalents will now occur to those skilled in the art. It is, therefore, to be understood that the appended claims are intended to cover all such embodiments and changes as fall within the true spirit of the invention.

What is claimed is:

1. A method comprising:
checking the vertical blanking interval of a video signal for an announcement signal;
when the announcement signal is found, operating in a first enhanced video mode;
when the announcement signal is not found, checking a predetermined trigger channel for the presence of a trigger signal; and
when the trigger signal is found, operating in a second enhanced video mode.

2. The method of claim 1 further comprising:
when the announcement signal is found, operating in a first enhanced video mode in which enhanced content is obtained from an address identified by the announcement signal.

3. The method of claim 1 in which the predetermined trigger channel is comprised by the vertical blanking interval of the video signal.

4. The method of claim one further comprising:
operating in a non-enhanced video mode when neither one of the announcement signal and trigger signal are found.

5. The method of claim one in which checking the vertical blanking interval of a video signal for an announcement signal further comprises:
checking for Internet Protocol packets in the vertical blanking interval; and
when the Internet Protocol packets comprise at least one of a predetermined set of address values, analyzing the Internet Protocol packets to identify the announcement signal.

6. An article comprising:
a machine-readable medium storing instructions which, when executed by a processor, result in
checking the vertical blanking interval of a video signal for an announcement signal;
when the announcement signal is found, operating in a first enhanced video mode;
when the announcement signal is not found, checking a predetermined trigger channel for the presence of a trigger signal; and
when the trigger signal is found, operating in a second enhanced video mode.

7. The article of claim 6 further comprising instructions which, when executed by the processor, result in:
when the announcement signal is found, operating in a first enhanced video mode in which enhanced content is obtained from an address identified by the announcement signal.

8. The article of claim 6 further comprising instructions which, when executed by the processor, result in:
when the announcement signal is not found, checking the vertical blanking interval of the video signal for the presence of a trigger signal.

9. The article of claim 6 further comprising instructions which, when executed by the processor, result in:
operating in a non-enhanced video mode when neither one of the announcement signal and trigger signal are found.

10. The article of claim 6 in which the instructions to check the vertical blanking interval of a video signal for an announcement signal, when executed by the processor, further result in:
checking for Internet Protocol packets in the vertical blanking interval; and
when the Internet Protocol packets comprise at least one of a predetermined set of address values, analyzing the Internet Protocol packets to identify the announcement signal.

11. A computer system comprising:
a processor;
a memory coupled to the processor and storing instructions which, when executed by the processor, result in
checking the vertical blanking interval of a video signal for an announcement signal;
when the announcement signal is found, operating in a first enhanced video mode;
when the announcement signal is not found, checking a predetermined trigger channel for the presence of a trigger signal; and
when the trigger signal is found, operating in a second enhanced video mode.

12. The system of claim 11 further comprising instructions which, when executed by the processor, result in:
when the announcement signal is found, operating in a first enhanced video mode in which enhanced content is obtained from an address identified by the announcement signal.

13. The system of claim 11 further comprising instructions which, when executed by the processor, result in:
when the announcement signal is not found, checking the vertical blanking interval of the video signal for the presence of a trigger signal.

14. The system of claim 11 further comprising instructions which, when executed by the processor, result in:
operating in a non-enhanced video mode when neither one of the announcement signal and trigger signal are found.

15. The system of claim 11 in which the instructions to check the vertical blanking interval of a video signal for an announcement signal, when executed by the processor, further result in:
checking for Internet Protocol packets in the vertical blanking interval; and
when the Internet Protocol packets comprise at least one of a predetermined set of address values, analyzing the Internet Protocol packets to identify the announcement signal.
